(19) United States
(12) Patent Application Publication
(10) Pub. No.: US 2008/0006704 A1
(43) Pub. Date: Jan. 10, 2008

(54) Smart card including a plurality of different interfaces

(75) Inventor: Sung-hyun Kim, Anyang-si (KR)

Correspondence Address: MILLS & ONELLO LLP, ELEVEN BEACON STREET, SUITE 605, BOSTON, MA, 02108, US

(73) Assignee: Samsung Electronics Co. Ltd., Suwon-si (KR)

(21) Appl. No.: 11/821,619

(22) Filed: Jun. 25, 2007

(30) Foreign Application Priority Data
Jul. 7, 2006 (KR) 10-2006-0063937

(51) Int. Cl. G06K 19/07

(52) U.S. Cl. 235/492

(57) ABSTRACT

A smart card includes contact pins and an IC chip electrically connected to the contact pins and having first interface units different from each other. The contact pins are selectively connected to one of the first interface units in accordance with an external interface mode.

### CROSS-REFERENCE TO RELATED APPLICATIONS

This U.S. non-provisional patent application claims priority under 35 U.S.C. § 119 of Korean Patent Application No. 10-2006-0063937 filed in the Korean Intellectual Property Office on Jul. 7, 2006, the entire contents of which are hereby incorporated by reference.

### BACKGROUND

The invention relates to smart cards. In particular, the present invention relates to a smart card including pluralities of different interfaces, a system associated with the smart card, and a communication method of the smart card.

Smart cards have integrated circuit (IC) chips for specific processing tasks by embedding microprocessors, card operating systems, security modules, and memories therein.

Smart cards carry out various functions such as operations, encryption, and bilateral communication, offering high security and portability for users. Smart cards are widely used in daily applications, e.g., traffic, medical services, personal identifications, product distributions, civil appeals, and so on.

Smart cards are mostly classified into two types: contact type and contactless type. Combination and hybrid cards are fabricated by merging the contact and contactless types. The contact card must physically contact a card reader so as to obtain power and clock signal for chip operation, while the contactless card is operable even at a distance from a card reader without insertion thereinto.

FIG. 1 shows a general contact-type smart card 100. The smart card 100 is fabricated and operable in accordance with the ISO7816 interface standard. Referring to FIG. 1, the smart card 100 includes a connector 120 and an IC chip 140.

As shown in FIG. 1, the connector 120 includes eight contact pins C1˜C8. The contact pin C1 is supplied with a power voltage Vcc, necessary for the smart card, from an external interface unit. The contact pin C2 receives a reset signal RST for resetting internal circuits of the smart card. The contact pin C3 is supplied with a clock CLK, stabilized for the IC chip 140, from the external interface unit. Here, the clock CLK functions to drive the IC chip 140. The contact pin C5 is supplied with a ground voltage GND from the external interface unit. The contact pins, C4, C5, and C6, are still undefined by the ISO7816 interface standard, as spare pins to be used for the future. Recent, these contact pins C4 and C8 are being used for transceiving data signals D+ and D− in accordance with the universal serial bus (USB) standard. The contact pin C7 is used as an input/output pin SIO necessary for the smart card 100 in executing a half-duplex communication mode with the external interface unit.

The conventional smart card 100 is generally compatible only with the ISO7816 interface protocol. Recent smart cards are mostly focused on extending their applications by being compatible with various interface protocols (e.g., USB, MMC, etc.). However, the number of contact pins of the smart card is limited to eight as shown in FIG. 1. This restriction creates difficulties in fabricating smart cards operable with various interface protocols.

### SUMMARY OF THE INVENTION

The present invention is directed to solve the aforementioned problems, providing a smart card compatible with various interface protocols even with a predetermined number of contact pins, a system including the smart card, and a data communication method thereof.

According to a first aspect, the present invention is directed to a smart card, comprising contact pins and an IC chip including first interface units electrically connectable to the contact pins and being different from each other. The contact pins are selectively connected to one of the first interface units in accordance with an external interface mode.

In one embodiment, the IC chip further includes an interface selection unit for determining the external interface mode and selecting one of the first interface units in accordance with a result of the determination.

In one embodiment, the interface selection unit comprises: a mode selection circuit generating a selection code to select one of the first interface units in response to a signal of one of the contact pins; and a multiplexer circuit connecting the first interface unit, which is selected by the selection code, with corresponding contact pins.

In one embodiment, the mode selection circuit generates the selection code by detecting a signal level of at least one of the contact pins.

In one embodiment, the mode selection circuit generates the selection code by detecting impedance of at least one of the contact pins.

In one embodiment, the interface selection unit comprises: a register storing mode set information; a mode selection circuit generating a selection code to select one of the first interface units in response to the mode set information; and a multiplexer circuit connecting the first interface unit, which is selected by the selection code, with corresponding contact pins.

In one embodiment, the first interface units include at least one of a USB interface unit, an MMC interface unit, and an SWP interface unit.

In one embodiment, the IC chip further includes a second interface unit connectable to the contact pins. In one embodiment, the second interface unit includes an ISO7816 interface unit.

According to another aspect, the invention is directed to a smart card, comprising: first contact pins; second contact pins; third contact pins; and an IC chip including an ISO7816 interface unit and other types of interface units. The first contact pins are connectable to the other types of interface units and the second contact pins are connectable to the ISO7816 interface unit, the first contact pins being selectively connected to one of the other types of interface units in accordance with an external interface mode. The third contact pins are shared by the ISO7816 interface units and the other types of interface units in supplying a power source voltage and a ground voltage.

In one embodiment, the IC chip further includes an interface selection unit determining the external interface mode and selecting one of the other types of interface units in accordance with a result of the determination. In one embodiment, the interface selection unit comprises: a mode selection circuit generating a selection code to select one of the other types of interface units in response to a signal of one of the first contact pins; and a multiplexer circuit connecting the interface unit, which is selected by the selection code, with corresponding first contact pins. In one embodiment, the mode selection circuit generates the selection code by detecting a signal level of at least one of the contact pins.

In one embodiment, the mode selection circuit generates the selection code by detecting impedance of at least one of the contact pins.

In one embodiment, the interface selection unit comprises: a register storing mode set information; a mode selection circuit generating a selection code to select one of the other types of interface units in response to the mode set information; and a multiplexer circuit connecting the interface unit selected by the selection code with corresponding of the contact pins.

In one embodiment, the other types of interface units include a USB interface unit, an MMC interface unit, and an SWP interface unit.

In one embodiment, the first contact pins are a fourth pin, a sixth pin, and an eighth pin in accordance with an ISO7816 interface standard; the second contact pins are a second pin, a third pin, and a seventh pin in accordance with the ISO7816 interface standard; and the third contact pins are a first pin and a fifth pin in accordance with the ISO7816 interface standard.

In one embodiment, the fourth pin is used for data input by an USB interface or data input and output by an MMC interface, the sixth pin is used for transferring a signal of an SWP interface or receiving a clock of the MMC interface, and the eighth pin is used for data output of the USB interface or exchange with a command of the MMC interface.

In one embodiment, the mode selection circuit determines to connect the fourth and eighth pins with the USB interface or the MMC interface by detecting a signal input to the fourth pin, and the mode selection circuit determines to connect the sixth pin with the SWP interface or the MMC interface from detecting a signal input to the sixth pin.

According to another aspect, the invention is directed to a system, comprising: a smart card; and a host communicating with the smart card. The smart card comprises: first contact pins; second contact pins; third contact pins; and an IC chip including an ISO7816 interface unit and other types of interface units. The first contact pins are connectable to the other types of interface units and the second contact pins are connectable to the ISO7816 interface unit, the first contact pins being selectively connected to one of the other types of interface units in accordance with an external interface mode. The third contact pins are shared by the ISO7816 interface units and the other types of interface units in supplying a power source voltage and a ground voltage.

According to another aspect, the invention is directed to a communication method of a smart card having contact pins and an IC chip connected to the contact pins. The method includes: selecting one of a plurality of different interfaces of the IC chip in accordance with a signal of at least one of the contact pins; selectively connecting the contact pins to the selected interface; and communicating with an external system through the selected interface.

According to another aspect, the invention is directed to a communication method of a smart card having contact pins and an IC chip connected to the contact pins. The method includes: selecting one of a plurality of different interfaces of the IC chip in accordance with mode set information stored in a register; selectively connecting the contact pins to the selected interface; and communicating with an external system through the selected interface.

A further understanding of the nature and advantages of the present invention herein may be realized by reference to the remaining portions of the specification and the attached drawings.

### BRIEF DESCRIPTION OF THE DRAWINGS

The foregoing and other features and advantages of the invention will be apparent from the more particular description of preferred aspects of the invention, as illustrated in the accompanying drawings in which like reference characters refer to the same parts throughout the different views. The drawings are not necessarily to scale, emphasis instead being placed upon illustrating the principles of the invention. FIG. 1 shows a general contact-type smart card.

FIG. 2 illustrates an embodiment of a smart card according to the present invention.

FIG. 3 illustrates an interface selection unit shown in FIG. 2.

FIG. 4 illustrates an auto-detection circuit of the mode selection circuit shown in FIG. 3.

FIG. 5 illustrates another embodiment of a smart card according to the present invention.

FIG. 6 illustrates an auto-detection circuit of the mode selection circuit shown in FIG. 5.

FIG. 7 illustrates a system including a host and the smart card shown in FIG. 2.

FIG. 8 illustrates a system in which a host shown in FIG. 7 is associated with an ISO7816 interface unit.

FIG. 9 illustrates a system in which the host shown in FIG. 7 is associated with a USB interface unit.

FIG. 10 illustrates a system in which the host shown in FIG. 7 is associated with an MMC interface unit.

FIG. 11 illustrates a system in which the host shown in FIG. 7 is associated with an SWP interface unit.

FIG. 12 shows a method of communicating with an external system by the smart card according to the present invention.

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

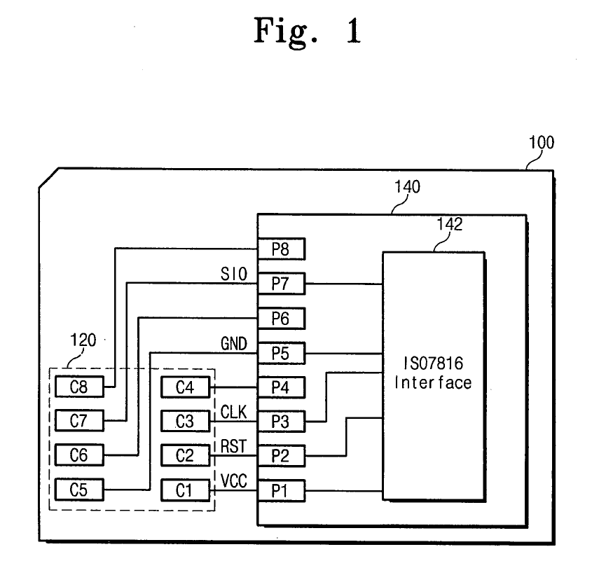

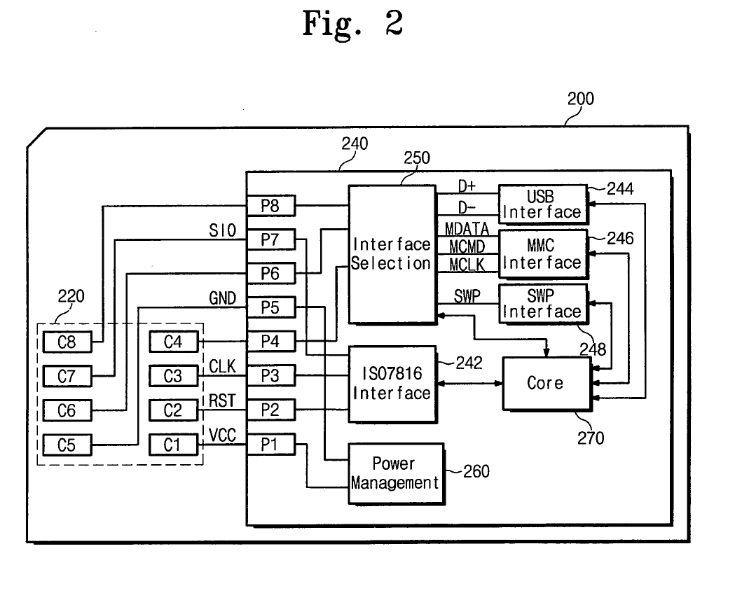

FIG. 2 illustrates an embodiment of a smart card 200 according to the present invention. Referring to FIG. 2, the smart card 200 includes a connector 220 and an IC chip 240.

The connector 220 is to be connected with an external interface unit. The connector 220 includes eight contact pins C1˜C8. The contact pins C1˜C8 are grouped into first contact pins C4, C6, and C8, second contact pins C2, C3, and C7, and third contact pins C1 and C5.

The first contact pins, C4, C6, and C8, are provided to select one among different interface units 244, 246, and 248, excluding an ISO7816 interface unit 242. The contact pin C4 is connected to a pad P4 of the IC chip 240. The contact pin C4 is used for receiving data D+ from an external USB interface unit or inputting/outputting data MDATA from/to an external MMC interface unit. The contact pin C6 is connected to a pad P6 of the IC chip 240. The contact pin C6 is used for exchanging a signal SWP with an external SWP interface unit or receiving a clock MCLK from the external MMC interface unit. The contact pin C8 is connected to a pad C8 of the IC chip 240. The contact pin C8 is used for outputting data D− to the external USB interface unit or exchanging a command CMD with the external MMC interface unit.

The second contact pins, C2, C3, and C7, are provided for supplying signals only to the ISO7816 interface unit 242. Referring to FIG. 2, the second contact pins, C2, C3, and C7, are connected to the ISO7816 interface unit 242. The contact pin C2 is connected to a pad P2 of the IC chip 240. The contact pin C2 is used for receiving a reset signal RST to reset internal circuits of the IC chip 240. The contact pin C3 is connected to a pad P3 of the IC chip 240. The contact pin C3 is used for supplying a stabilized clock CLK to the IC chip 240 from an external system. The IC chip 240 is driven in sync with the clock CLK. The contact pin C7 is connected to a pad C7 of the IC chip 240. The contact pin C7 is used for exchanging input/output data SIO with the external system in a half-duplex mode.

The third contact pins, C1 and C4, are provided to supply a power source voltage VCC and a ground voltage GND to internal circuits of the IC chip 240. The contact pin C1 is used for accepting the power source voltage VCC from the external system for driving the IC chip 240. The contact pin C5 is connected to a pad P5 of the IC chip 240. The contact pin C5 is used for providing an electrical ground GND between the IC chip 240 and the external system. Referring to FIG. 2, the pads P1 and P5 are connected to a power management unit 260. The power management unit 260 supplies internal circuits of the IC chip 240 with the power source and ground voltages VCC and GND that are transferred through the pads P1 and P5.

The IC chip 240 includes the pads P1˜P8, the ISO7816 interface unit 242, the USB interface unit 244, the MMC interface unit 246, the SWP interface unit 248, an interface selection unit 250, the power management unit 260, and a core block 270.

The power management unit 260 receives the power source voltage VCC and the ground voltage GND respectively from the pads P1 and P5, and supplies the power source voltage VCC and the ground voltage GND into the internal circuits of the IC chip 240.

The core block 270, although not shown in FIG. 2, includes a CPU, a memory (e.g., a ROM, a RAM, or a flash memory), and a security logic circuit.

Referring to FIG. 2, the ISO7816 interface unit 242, the USB interface unit 244, the MMC interface unit 246, and the SWP interface unit 248 share the power management unit 260 and the core block 270.

As illustrated in FIG. 2, the smart card 200 is configured in connection with the ISO7816 interface unit 242 as a basic mode. Otherwise, the USB interface unit 244, the MMC interface unit 246, and the SWP interface unit 248 are electrically connected in accordance with signals input through the first pads P4, P6, and P8.

The following Table 1 summarizes functions of the pads in the smart card 200.

TABLE 1

| | ISO7816 | USB | MMC | SWP |
|---|---|---|---|---|
| P1 | VCC | VCC | VCC | — |
| P2 | RST | — | — | — |
| P3 | CLK | — | — | — |
| P4 | — | D+ | MDATA | — |
| P5 | GND | GND | GND | — |
| P6 | — | — | MCLK | SWP |
| P7 | SIO | — | — | — |
| P8 | — | D− | MCMD | — |

The ISO7816 interface unit 242 receives the reset signal RST through the pad P2 and the clock CLK through the pad P3, and exchanges the input/output data SIO through the pad P7. The ISO7816 interface unit 242 is supplied with the power source voltage VCC through the pad P1, by the power management unit 260, and the ground voltage GND through the pad P5.

The USB interface unit 244 receives the data D+ through the pad P4, via the interface selection unit 250, and outputs the data D− through the pad P8. The USB interface unit 244 is supplied with the power source voltage VCC through the pad P1, via the power management unit 260, and the ground voltage GND through the pad P5.

The MMC interface unit 246 inputs and outputs the data MDATA through the pad P4, via the interface selection unit 250, and receives the clock MCLK through the pad P6, exchanging the command MCMD through the pad P8. The MMC interface unit 246 is supplied with the power source voltage VCC through the pad P1, via the power management unit 260, and the ground voltage GND through the pad P5.

The SWP interface unit 248 receives the signal SWP through the pad P6 via the interface selection unit 250. Since the signal SWP is applied with power thereto, the SWP interface unit 246 need not be supplied with an additional power connection.

The interface selection unit 250 determines an interface mode to the external system by sensing signals input through the first pads P4, P6, and P8 from the external system, and selects one of the interface units 244, 246, and 248 in accordance with a result of the determination. As shown in FIG. 2, the interface selection unit 250 transfers the signals to a selected interface unit from the first pads P4, P6, and P8.

If the USB interface mode is selected or determined, the interface selection unit 250 electrically connects the pad P4 for the input data D+ and the pad P8 for the output data D− to the USB interface unit 244.

If the MMC interface mode is selected or determined, the interface selection unit 250 electrically connects the pad P4 for the input/output data MDATA, the pad P6 for the clock CLK, and the pad P8 for the output data D− to the MMC interface unit 246.

If the SWP interface mode is selected or determined, the interface-selection unit 250 electrically connects the pad P6 for the signal SWP to the SWP interface unit 248.

The smart card 200 according to the present invention determines an interface mode to the external system by sensing signals input through the first pads P4, P6, and P8 from the external system, selects one of the interface units in accordance with a result of the determination, and electrically connects a selected interface unit to correspondents of the first pads P4, P6, and P8.

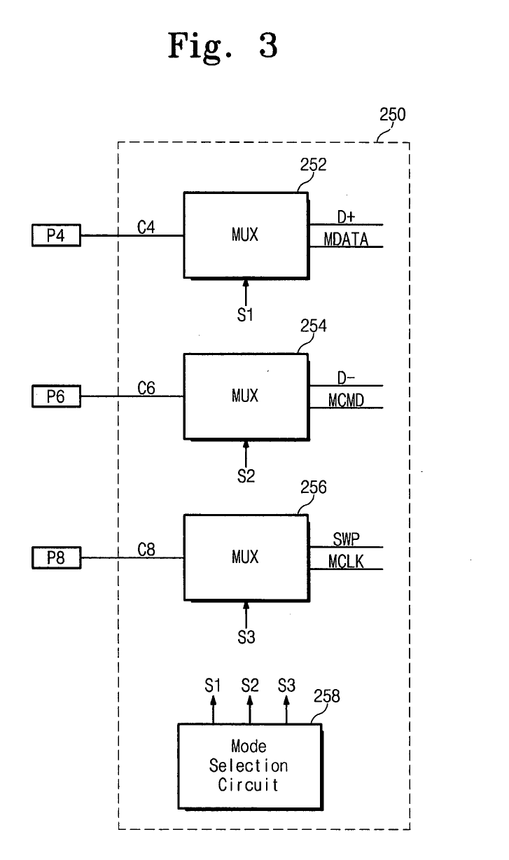

FIG. 3 illustrates the interface selection circuit 250 shown in FIG. 2. The interface selection unit 250 is comprised of a first multiplexer 252, a second multiplexer 254, a third multiplexer 256, and a mode selection circuit 258.

The first multiplexer 252 determines a signal, which is input through the pad P4, into the output data D+ of the USB interface unit 244 or the data MDATA of the MMC interface unit 246 in response to a selection code S1 provided from the mode selection circuit 258.

The second multiplexer 254 determines a signal, which is input through the pad P6, into the output data D− of the USB interface unit 244 or the data MCMD of the MMC interface unit 246 in response to a selection code S2 provided from the mode selection circuit 258.

The third multiplexer 252 determines a signal, which is input through the pad P8, into the signal SWP of the SWP interface unit 248 or the clock MCLK of the MMC interface unit 246 in response to a selection code S3 provided from the mode selection circuit 258.

The mode selection circuit 258 generates the selection codes S1, S2, and S3 for determining an interface mode. Here, the selection codes S1˜S3 may be selected by a user or generated automatically.

A user may set the selection codes S1˜S3 in the following manner. First, the user establishes information about the selection codes S1˜S3 in a register in correspondence each with the interface modes. The selection codes S1˜S3 established in the register are transferred to the mode selection circuit 258.

Therefore, the user can make a selection for rendering the smart card 200 to be operable with a specific interface unit in accordance with the selection codes S1˜S3 established in the register. The following Table 2 exemplarily shows interface units selected by the codes S1˜S3 established in the register.

TABLE 2

| Selected interface | S1 | S2 | S3 |
|---|---|---|---|
| USB | 1 | 1 | 0 |
| MMC | 0 | 0 | 0 |
| SWP | 0 | 0 | 1 |

If the selection codes are set as S1=1, S2=1, and S3=0 in the register, the smart card 200 is used exclusively for communication in the USB interface mode. If the selection codes are set as S1=1, S2=0, and S3=0 in the register, the smart card 200 is used exclusively for communication in the MMC interface mode. If the selection codes are set as S1=1, S2=0, and S3=1 in the register, the smart card 200 is used exclusively for communication in the SWP interface mode.

The mode selection circuit 258 detects signals transferred to the first pads P4, P6, and P8 and generates the selection codes S1˜S3 automatically. For this operation, the mode selection circuit 258 is required to further include an auto-detection circuit for detecting the signals transferred to the first pads P4, P6, and P8.

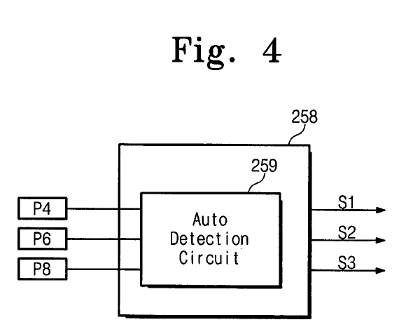

FIG. 4 illustrates an auto-detection circuit 259 of the mode selection circuit shown in FIG. 3. The auto-detection circuit 259 generates the sensing codes S1˜S3 from detecting signal level differences of the signals input to the first pads P4, P6, and P8 and impedance gaps of the pads.

Signals input by different interface modes are also dissimilar to each other in voltage level. The smart card 200 stores voltage levels of the signals according to the different interface modes. The auto-detection circuit 259 determines an interface mode to the external system by comparing voltage levels of signals of the pads with the values stored in the smart card 200.

Although not shown herein, the auto-detection circuit 259 for detecting impedance gaps of the pads operates as follows. The auto-detection circuit 259 evaluates voltage levels of the pads with varying impedances around the pads to which signals are applied from the external system. Data information of the voltage levels are compared with interface values stored in the smart card 200, from which it determines an interface mode to the external system.

The interface selection unit 250 determines an interface mode from detecting signals of the first pads P4, P6, and P8, selects an interface unit with reference to a result of the determination, and makes electrical connections for pads of the first pads P4, P6, and P8 in correspondence with the selected interface mode.

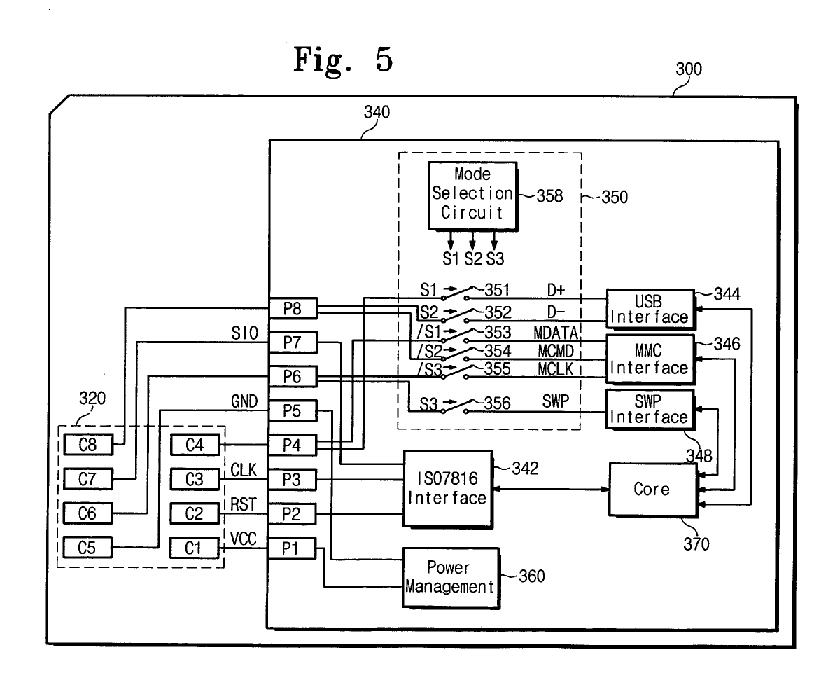

FIG. 5 illustrates another embodiment of a smart card 300 according to the present invention. Referring to FIG. 5, the smart card 300 includes the first pads P4, P6, and P8 those are connected to signal lines of interface units 344, 346, and 348 in double bonding pattern. The pad P4 is connected to the data input line D+ of the USB interface unit 344 and the data line MDATA of the MMC interface unit 346. The pad P6 is connected to the signal line SWP of the SWP interface unit 348 and the clock line MCLK of the MMC interface unit 346. The pad P8 is connected to the data output line D− of the USB interface unit 344 and the command line MCMD of the MMC interface unit 346.

An interface selection unit 350 includes switches 351˜356 and a mode selection circuit 358. The switches 351˜356 determine and control connections between the first pads P4, P6, and P8 and the interface units 344, 346, and 348 in response to the selection codes S1, S2, and S3 provided from a mode selection circuit 358.

The switch 351 determines to electrically connect the pad P4 with the input data line D+ of the USB interface unit 344 in response to the selection code S1. The switch 352 determines to electrically connect the pad P8 with the output data line D− of the USB interface unit 344 in response to the selection code S2. The switch 353 determines to electrically connect the pad P4 with the data line MDATA of the MMC interface unit 346 in response to the selection code S1. The switch 354 determines to electrically connect the pad P8 with the command line MCMD of the MMC interface unit 346 in response to the selection code S2. The switch 355 determines to electrically connect the pad P6 with the signal line SWP of the SWP interface unit 348 in response to the selection code S3. The switch 356 determines to electrically connect the pad P6 with the clock line MCLK of the MMC interface unit 346 in response to the selection code S3.

The mode selection circuit 358 detects signals transferred to the first pads P4, P6, and P8 and generates the selection codes S1˜S3 to be applied to the switches 351˜356. For this operation, the mode selection circuit 358 is needed to further include an auto-detection circuit.

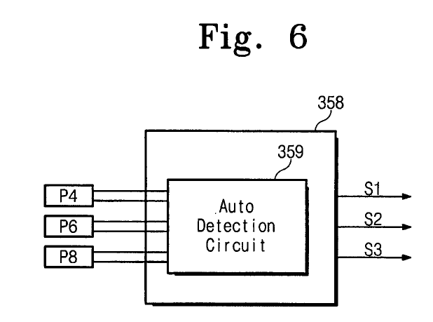

FIG. 6 illustrates an auto-detection circuit 359 in accordance with the present invention. The auto-detection circuit 359 shown in FIG. 6 generates the selection codes S1˜S3 from sensing voltage levels of signals input to the first pads P4, P6, and P8 or impedance gaps of the pads.

The auto-detection circuit 359 determines an interface mode to communicate with an external system from sensing signals input to the first pads P4, P6, and P8, and applies the selected code values to the switches 351˜356. The interface selection unit 350 determines to turn the switches 351˜356 on or off in accordance with the selection code values of the auto-detection circuit 359, and electrically connects correspondents of the first pads P4, P6, and P8 to the selected interface unit.

Referring to FIGS. 5 and 6, the smart card 300 conducts electrical interconnections with the interface units according to the following procedure. In a default basic mode, the smart card 300 is basically connected to the ISO7816 interface unit 342 and the switches 351 are all conditioned in open states.

If the smart card 300 is to communicate with an external system in the USB interface mode, the auto-detection circuit 359 of the smart card 300 generates the selection codes S1 and S2 from sensing signals input to the pads P4 and P8. The switches 351 and 352 are turned on by the selection codes S1 and S2 generated from the auto-detection circuit 359. Thus, the USB interface unit 344 is automatically connected to the pad P4, which receives the input data D+, and the pad P8 outputting the output data D−. Then, the smart card 300 is able to communicate with the external system in the USB interface mode.

If the smart card 300 is to communicate with an external system in the MMC interface mode, the auto-detection circuit 359 of the smart card 300 generates the selection codes /S1, /S2, and /S3 from sensing signals input to the pads P4, P6, and P8. The switches 353, 354, and 355 are turned on by the selection codes /S1, /S2, and S3 generated from the auto-detection circuit 359. Thus, the MMC interface unit 346 is automatically connected to the pad P4 inputting or outputting the data MDATA, the pad P6 receiving the clock MCLK, and the pad P8 receiving the clock MCLK. Then, the smart card 300 is able to communicate with the external system in the MMC interface mode.

If the smart card 300 is to communicate with an external system in the SWP interface mode, the auto-detection circuit 359 of the smart card 300 generates the selection code S3 from sensing a signal input to the pad P6. The switch 356 is turned on by the selection code S3 generated from the auto-detection circuit 359. Thus, the SWP interface unit 344 is automatically connected to the pad P6 inputting or outputting the signal SWP. Then, the smart card 300 is able to communicate with the external system in the SWP interface mode.

As stated above, the smart card 300 of the present invention generates selection code values to select an interface unit for communication with an external system by sensing signals input to the first pads P4, P6, and P8. Responding to the selection code values, pads of the first pads P4, P6, and P8, corresponding to a selected interface mode, are electrically connected to a selected interface unit, making the smart card 300 communicate with the external system.

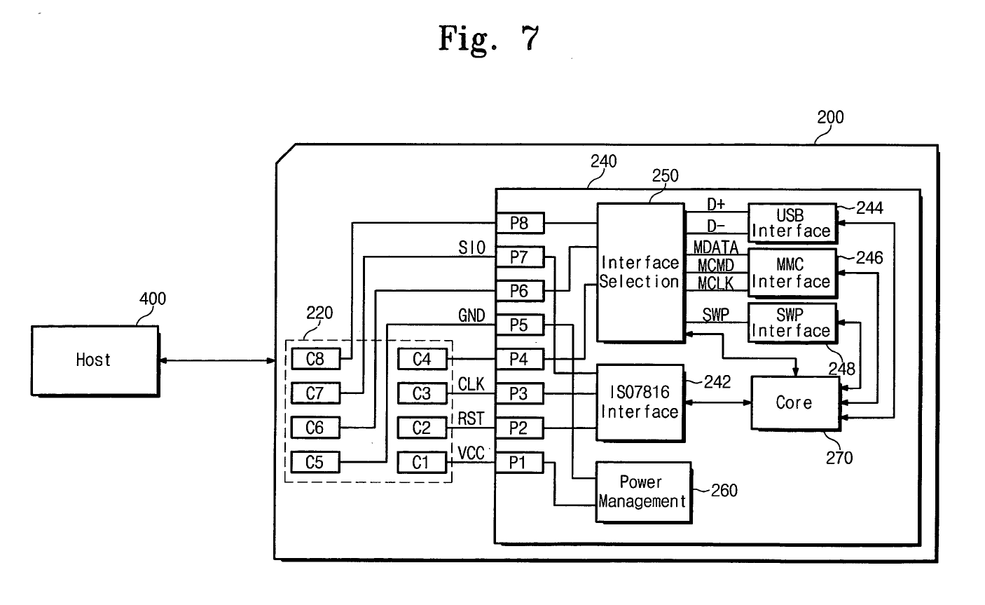

FIG. 7 illustrates a system including a host 400 and the smart card 200 shown in FIG. 2. Referring to FIG. 7, the system is comprised of the smart card 200 and the host 400. The host 400 includes one of the ISO7816 interface unit, the USB interface unit, the MMC interface unit, and the SWP interface unit. The smart card 200 according to the present invention is able to communicate with various external interface units (e.g., the USB interface unit, the MMC interface unit, or the SWP interface unit).

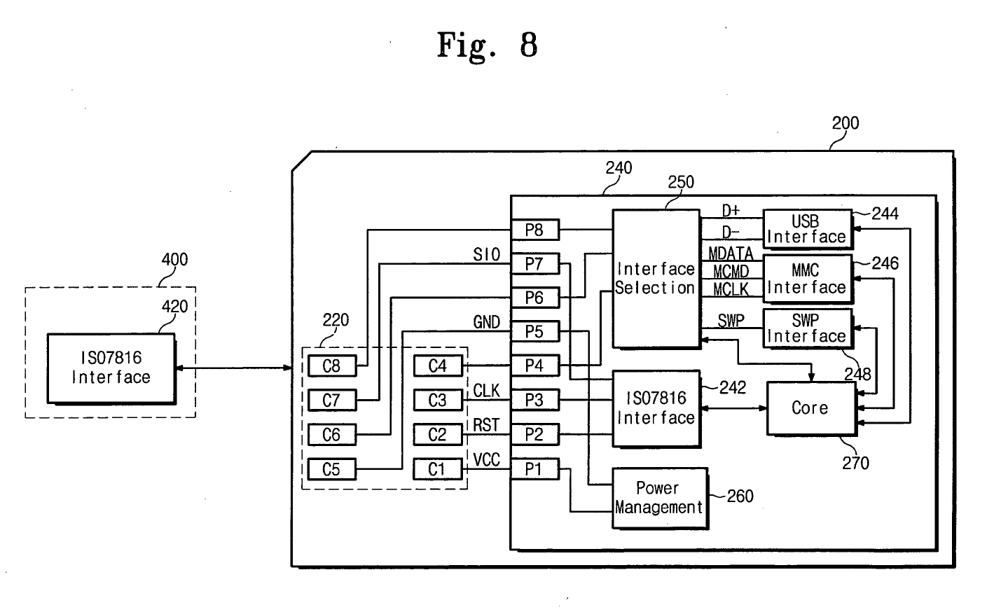

FIG. 8 illustrates a system in which the host 400 shown in FIG. 7 is associated with an ISO7816 interface unit 420. Referring to FIG. 8, the smart card 200 is able to basically communicate with the host 400 including the ISO7816 interface unit 420.

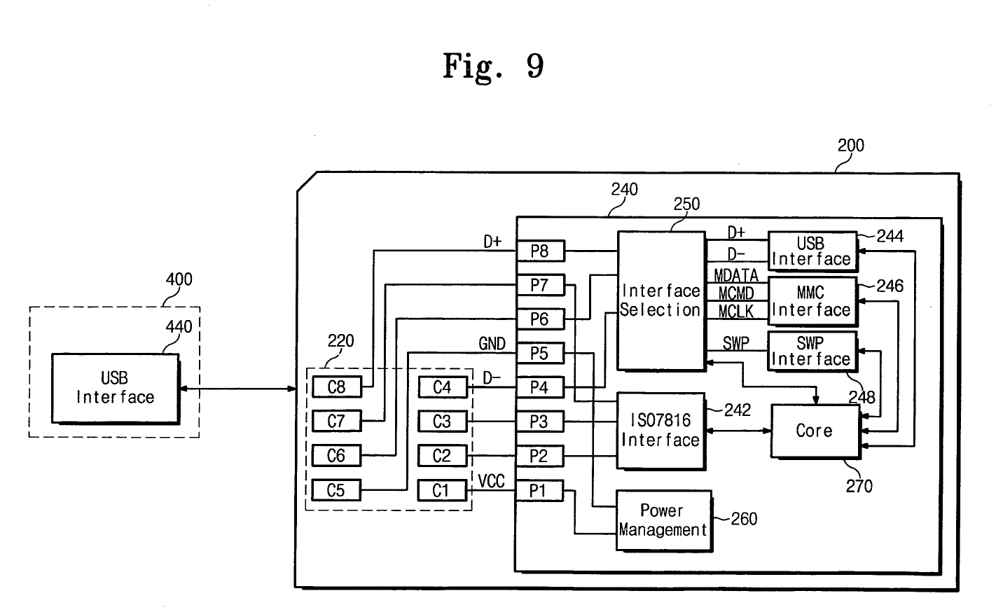

FIG. 9 illustrates a system in which the host 400 shown in FIG. 7 is associated with a USB interface unit 440. The interface selection unit 250 finds that the interface mode operated by the smart card 200 is the USB interface mode, by sensing signals of the pads P4 and P8 transferred from the host 400. Thus, the smart card 200 identifies the signals, which are transferred to the pads P4 and P8, as the input and output data D+ and D− of the USB interface unit 244. The smart card 200 is supplied with the power source voltage VCC from the pad P1, through the power management unit 260 and the ground voltage GND from the padP5.

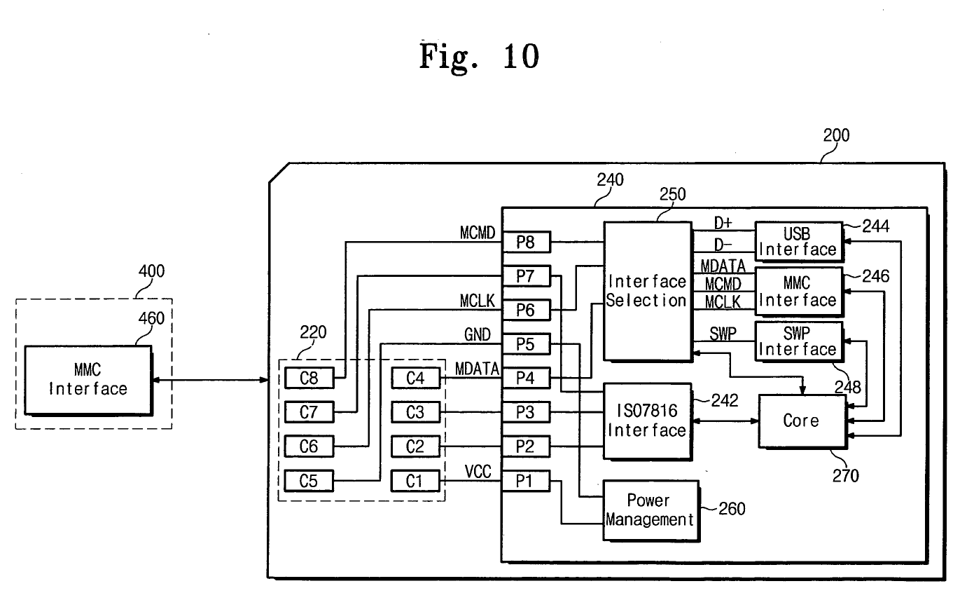

FIG. 10 illustrates a system in which the host 400 shown in FIG. 7 is associated with an MMC interface unit 460. The interface selection unit 250 finds that the interface mode operated by the smart card 200 is the MMC interface mode, by sensing signals of the pads P4, P6, and P8 transferred from the host 400. Thus, the smart card 200 identifies the signals, which are transferred to the pads P4, P6, and P8, as the input/output data MDATA, the clock MCLK, and the command MCMD of the MMC interface unit 246, respectively. The smart card 200 is supplied with the power source voltage VCC from the pad P1, through the power management unit 260 and the ground voltage GND from the pad P5.

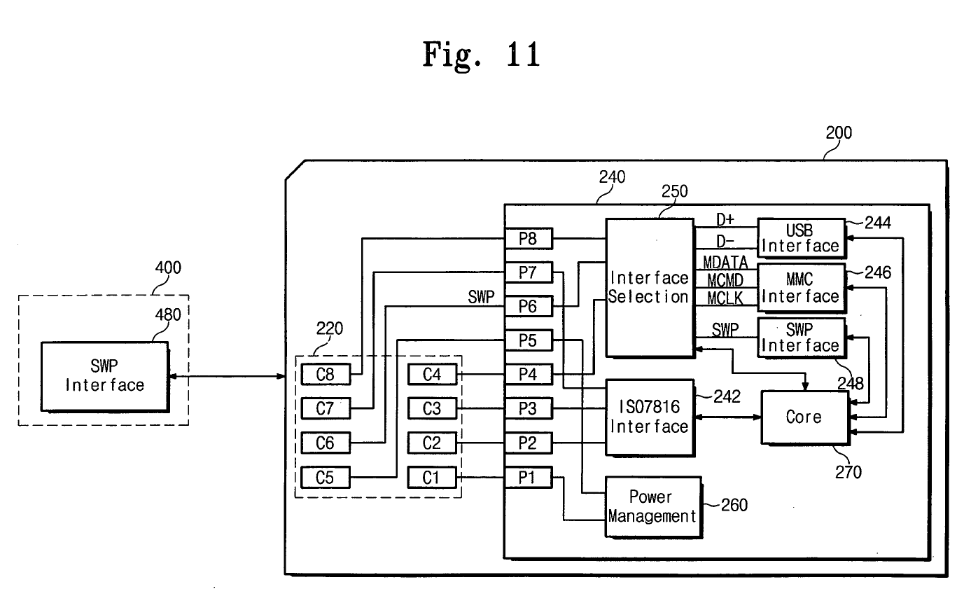

FIG. 11 illustrates a system in which the host 400 shown in FIG. 7 is associated with an SWP interface unit 480. The interface selection unit 250 finds that the interface mode operated by the smart card 200 is the SWP interface mode, by sensing a signal of the pad P6 transferred from the host 400. Thus, the smart card 200 identifies the signal, which is transferred to the pad P6, as the signal SWP of the MMC interface unit 248.

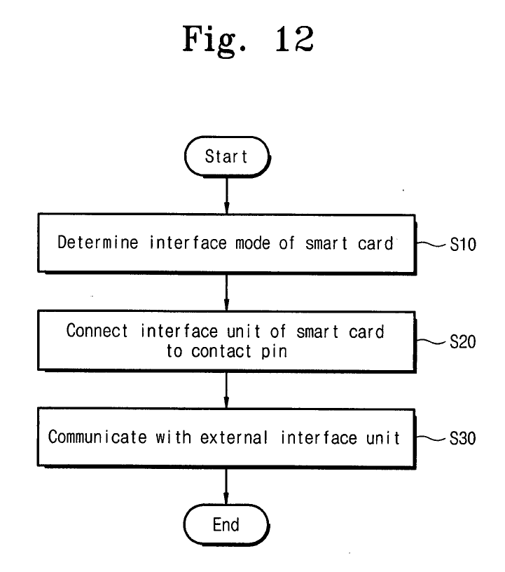

FIG. 12 shows a method of communicating with an external system by the smart card 200 according to the present invention. The smart card 200 includes pluralities of the different interface units. The interface units share the pads of the smart card for communication with the external system.

Referring to FIG. 12, a method of communicating with the external system by the smart card 200 is as follows. First, in a step S10, the smart card 200 determines an interface mode for communicating with the external system. Determining an interface mode is conducted by a user or automatically by sensing a signal transferred from a pad contacting with the external system.

Next, in a step S20, the smart card 200 operates to electrically connect a selected interface unit with the shared pad so as to enable communication in accordance with the interface mode selected by the step S10. In the step S20, the remaining deselected interface units are electrically disconnected from the shared pad.

Then, in a step S30, the smart card 200 begins to conduct data communication with the external system through the pad connected thereto by the step S20.

Accordingly, the smart card is able to include different interface units, enabling data communication with various external interface units (e.g., 420, 440, 460, and 460) even with a restrictive number of pads.

In summary, the present invention offers a smart card including different kinds of interface units, capable of communicating data with various external interfacing systems even with a restrictive number of contact pins.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A smart card, comprising:
contact pins; and
an IC chip including first interface units electrically connectable to the contact pins and being different from each other,
wherein the contact pins are selectively connected to one of the first interface units in accordance with an external interface mode.

2. The smart card as set forth in claim 1, wherein the IC chip further includes an interface selection unit for determining the external interface mode and selecting one of the first interface units in accordance with a result of the determination.

3. The smart card as set forth in claim 2, wherein the interface selection unit comprises:
a mode selection circuit generating a selection code to select one of the first interface units in response to a signal of one of the contact pins; and
a multiplexer circuit connecting the first interface unit, which is selected by the selection code, with corresponding contact pins.

4. The smart card as set forth in claim 3, wherein the mode selection circuit generates the selection code by detecting a signal level of at least one of the contact pins.

5. The smart card as set forth in claim 3, wherein the mode selection circuit generates the selection code by detecting impedance of at least one of the contact pins.

6. The smart card as set forth in claim 2, wherein the interface selection unit comprises:
a register storing mode set information;
a mode selection circuit generating a selection code to select one of the first interface units in response to the mode set information; and
a multiplexer circuit connecting the first interface unit, which is selected by the selection code, with corresponding contact pins.

7. The smart card as set forth in claim 1, wherein the first interface units include at least one of a USB interface unit, an MMC interface unit, and an SWP interface unit.

8. The smart card as set forth in claim 1, wherein the IC chip further includes a second interface unit connectable to the contact pins.

9. The smart card as set forth in claim 8, wherein the second interface unit includes an ISO7816 interface unit.

10. A smart card, comprising:
first contact pins;
second contact pins;
third contact pins; and
an IC chip including an ISO7816 interface unit and other types of interface units,
wherein the first contact pins are connectable to the other types of interface units and the second contact pins are connectable to the ISO7816 interface unit, the first contact pins being selectively connected to one of the other types of interface units in accordance with an external interface mode,
wherein the third contact pins are shared by the ISO7816 interface units and the other types of interface units in supplying a power source voltage and a ground voltage.

11. The smart card as set forth in claim 10, wherein the IC chip further includes an interface selection unit determining the external interface mode and selecting one of the other types of interface units in accordance with a result of the determination.

12. The smart card as set forth in claim 11, wherein the interface selection unit comprises:
a mode selection circuit generating a selection code to select one of the other types of interface units in response to a signal of one of the first contact pins; and
a multiplexer circuit connecting the interface unit, which is selected by the selection code, with corresponding first contact pins.

13. The smart card as set forth in claim 12, wherein the mode selection circuit generates the selection code by detecting a signal level of at least one of the contact pins.

14. The smart card as set forth in claim 12, wherein the mode selection circuit generates the selection code by detecting impedance of at least one of the contact pins.

15. The smart card as set forth in claim 11, wherein the interface selection unit comprises:
a register storing mode set information;
a mode selection circuit generating a selection code to select one of the other types of interface units in response to the mode set information; and
a multiplexer circuit connecting the interface unit selected by the selection code with corresponding of the contact pins.

16. The smart card as set forth in claim 10, wherein the other types of interface units include a USB interface unit, an MMC interface unit, and an SWP interface unit.

17. The smart card as set forth in claim 13, wherein: the first contact pins are a fourth pin, a sixth pin, and an eighth pin in accordance with an ISO7816 interface standard; the second contact pins are a second pin, a third pin, and a seventh pin in accordance with the ISO7816 interface standard; and the third contact pins are a first pin and a fifth pin in accordance with the ISO7816 interface standard.

18. The smart card as set forth in claim 17, wherein the fourth pin is used for data input by an USB interface or data input and output by an MMC interface,
wherein the sixth pin is used for transferring a signal of an SWP interface or receiving a clock of the MMC interface,
wherein the eighth pin is used for data output of the USB interface or exchange with a command of the MMC interface.

19. The smart card as set forth in claim 18, wherein the mode selection circuit determines to connect the fourth and eighth pins with the USB interface or the MMC interface by detecting a signal input to the fourth pin,
wherein the mode selection circuit determines to connect the sixth pin with the SWP interface or the MMC interface from detecting a signal input to the sixth pin.

20. A system, comprising:
a smart card; and
a host communicating with the smart card,
wherein the smart card comprises:
first contact pins;
second contact pins;
third contact pins; and
an IC chip including an ISO7816 interface unit and other types of interface units,
wherein the first contact pins are connectable to the other types of interface units and the second contact pins are connectable to the ISO7816 interface unit, the first contact pins being selectively connected to one of the other types of interface units in accordance with an external interface mode, wherein the third contact pins are shared by the ISO7816 interface units and the other types of interface units in supplying a power source voltage and a ground voltage.

21. A communication method of a smart card having contact pins and an IC chip connected to the contact pins, which comprises:
selecting one of a plurality of different interfaces of the IC chip in accordance with a signal of at least one of the contact pins;
selectively connecting the contact pins to the selected interface; and
communicating with an external system through the selected interface.

22. A communication method of a smart card having contact pins and an IC chip connected to the contact pins, which comprises:
selecting one of a plurality of different interfaces of the IC chip in accordance with mode set information stored in a register;
selectively connecting the contact pins to the selected interface; and
communicating with an external system through the selected interface.
